(19) United States
(12) Patent Application Publication
(10) Pub. No.: US 2024/0233693 A9
(43) Pub. Date: Jul. 11, 2024

(54) AUTOMATIC PERFORMANCE DEVICE, NON-TRANSITORY COMPUTER-READABLE MEDIUM, AND AUTOMATIC PERFORMANCE METHOD

(71) Applicant: Roland Corporation, Shizuoka (JP)

(72) Inventors: Tomoko ITO, Hamamatsu (JP); Ikuo TANAKA, Hamamatsu (JP); Yoriko SASAMORI, Hamamatsu (JP); Takaaki HAGINO, Hamamatsu (JP)

(73) Assignee: Roland Corporation, Shizuoka (JP)

(21) Appl. No.: 18/460,662

(22) Filed: Sep. 4, 2023

(30) Foreign Application Priority Data
Oct. 24, 2022 (JP) 2022-169862

(51) Int. Cl. G10H 1/00; G10H 1/34; G10H 1/40; G10H 1/46

(52) U.S. Cl. CPC G10H 1/0025; G10H 1/34; G10H 1/40; G10H 1/46; G10H 2210/005; G10H 2210/066; G10H 2210/071; G10H 2210/111; G10H 2220/221; G10H 2220/271

(57) ABSTRACT

An automatic performance device includes: a pattern storage part, storing a plurality of performance patterns; a performing part, performing a performance based on the performance pattern stored in the pattern storage part; an input part, inputting performance information from an input device; a rhythm detection part, detecting a rhythm from the performance information inputted by the input part; an acquisition part, acquiring from among the plurality of performance patterns stored in the pattern storage part the performance pattern corresponding to the rhythm detected by the rhythm detection part; and a switching part, switching the performance pattern being performed by the performing part to the performance pattern acquired by the acquisition part.

### CROSS-REFERENCE TO RELATED APPLICATIONS

This application claims the priority benefit of Japan Application No. 2022-169862, filed on Oct. 24, 2022. The entirety of the above-mentioned patent application is hereby incorporated by reference herein and made a part of this specification.

### BACKGROUND

### Technical Field

The disclosure relates to an automatic performance device, an automatic performance program, and an automatic performance method.

### Related Art

Japanese Patent Laid-Open No. 2021-113895 discloses an electronic musical instrument which repeatedly reproduces a patterned accompaniment sound created based on accompaniment style data ASD. The accompaniment style data ASD includes a plurality of accompaniment section data according to combinations of a “section” such as intro, main section, and ending, and a “liveliness level” such as quiet, slightly loud, and loud. From among the accompaniment style data ASD, a performer selects, via a setting operation part 102, the accompaniment section data corresponding to the section and liveliness level of a musical piece being performed. Accordingly, in addition to the musical piece being performed, a patterned accompaniment sound suitable for that musical piece can be outputted.

However, when a melody of the musical piece being performed by the performer changes and does not match the liveliness level of the patterned accompaniment sound being outputted, there arises a need to switch the patterned accompaniment sound. In this case, a problem occurs that the performer, while performing, has to manually select via the setting operation part 102 the accompaniment section data matching the changed melody from among the accompaniment style data ASD.

### SUMMARY

An automatic performance device according to the disclosure includes: a pattern storage part, storing a plurality of performance patterns; a performing part, performing a performance based on the performance pattern stored in the pattern storage part; an input part, inputting performance information from an input device; a rhythm detection part, detecting a rhythm from the performance information inputted by the input part; an acquisition part, acquiring from among the plurality of performance patterns stored in the pattern storage part the performance pattern corresponding to the rhythm detected by the rhythm detection part; and a switching part, switching the performance pattern being performed by the performing part to the performance pattern acquired by the acquisition part.

A non-transitory computer-readable medium according to the disclosure stores an automatic performance program that causes a computer to execute automatic performance. The computer includes a storage part and an input part that inputs performance information. The automatic performance program causes the storage part to function as a pattern storage part storing a plurality of performance patterns, and causes the computer to: perform a performance based on the performance pattern stored in the pattern storage part; input the performance information by the input part; detect a rhythm from the inputted performance information; acquire from among the plurality of performance patterns stored in the pattern storage part the performance pattern corresponding to the detected rhythm; and switch the performance pattern being performed to the acquired performance pattern.

An automatic performance method according to the disclosure is executed by an automatic performance device including a pattern storage part storing a plurality of performance patterns and an input device inputting performance information. The automatic performance method includes following. A performance is performed based on the performance pattern stored in the pattern storage part. The performance information is inputted by the input device. A rhythm is detected from the inputted performance information. The performance pattern corresponding to the detected rhythm is acquired from among the plurality of performance patterns stored in the pattern storage part. The performance pattern being performed is switched to the acquired performance pattern.

### BRIEF DESCRIPTION OF THE DRAWINGS

FIG. 1 is an external view of a synthesizer in one embodiment.

FIG. 2 shows in each of (a) to (c) a diagram representing a rhythm pattern, shows in (d) a diagram representing a case where an average value of velocity is greater than an intermediate value of velocity, shows in (e) a diagram representing a change in drum volume in the case where the average value of velocity is greater than the intermediate value of velocity, shows in (f) a diagram representing a change in bass volume in the case where the average value of velocity is greater than the intermediate value of velocity, shows in (g) a diagram representing a change in velocity in a case where the average value of velocity is less than the intermediate value of velocity, shows in (h) a diagram representing a change in drum volume in the case where the average value of velocity is less than the intermediate value of velocity, shows in (i) a diagram representing a change in bass volume in the case where the average value of velocity is less than the intermediate value of velocity, and shows in (j) a diagram representing a key range on a keyboard.

FIG. 3 is a functional block diagram of a synthesizer.

FIG. 4 shows in (a) a block diagram illustrating an electrical configuration of a synthesizer, shows in (b) a schematic diagram of a rhythm table, and shows in (c) a schematic diagram of a style table.

FIG. 5 is a flowchart of main processing.

FIG. 6 is a flowchart of performance pattern switching processing.

FIG. 7 is a flowchart of performance pattern volume changing processing.

### DESCRIPTION OF THE EMBODIMENTS

The disclosure provides an automatic performance device, an automatic performance program, and an automatic performance method which make it possible to automatically switch to a performance pattern suitable for a performer's performance.

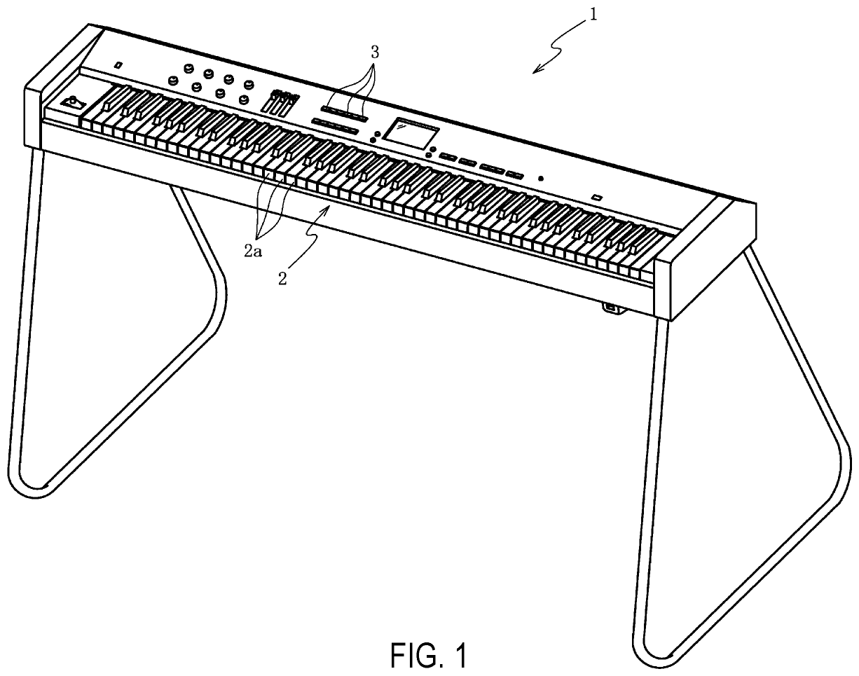

Hereinafter, embodiments will be described with reference to the accompanying drawings. FIG. 1 is an external view of a synthesizer 1 in one embodiment. The synthesizer 1 is an electronic musical instrument (automatic performance device) that mixes a musical sound generated by a performance operation of a performer (user), a predetermined accompaniment sound and the like and outputs (emits) a mixed sound. The synthesizer 1 is able to apply an effect such as reverberation, chorus, or delay by performing arithmetic processing on waveform data in which the musical sound generated by the performer's performance, the accompaniment sound and the like are mixed together.

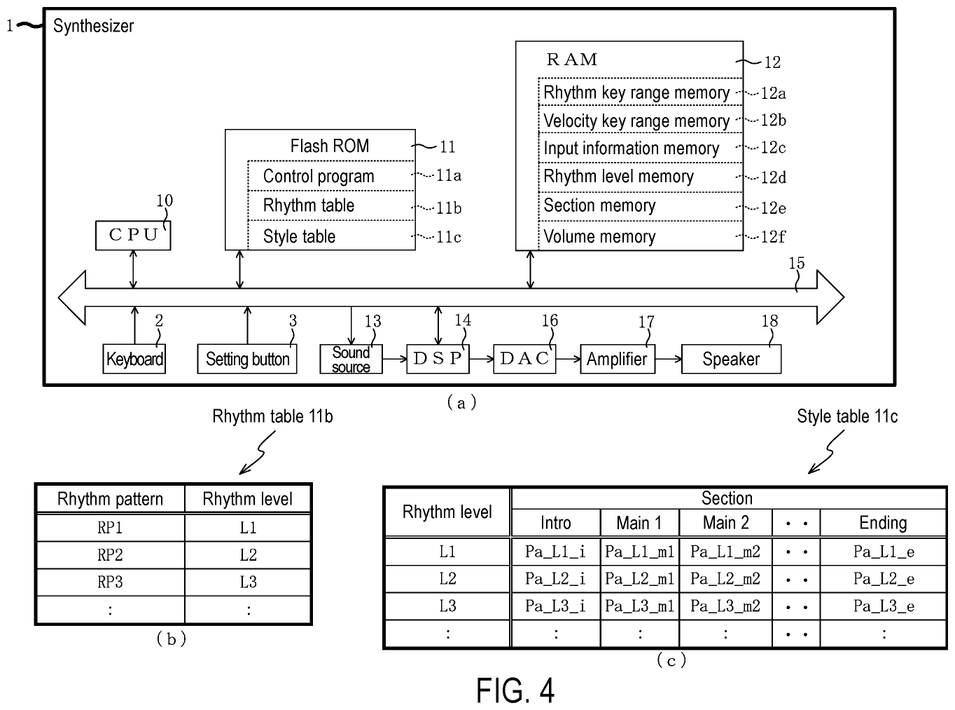

As illustrated in FIG. 1, the synthesizer 1 is mainly provided with a keyboard 2, and a setting button 3 to which various settings from the performer are inputted. The keyboard 2 is provided with a plurality of keys 2a, and is an input device for acquiring performance information according to the performer's performance. The performance information of the musical instrument digital interface (MIDI) standard according to a key depression/release operation (that is, performance operation) performed by the performer on the key 2a is outputted to a CPU 10 (see FIG. 4).

In the synthesizer 1 of the present embodiment, a plurality of performance patterns Pa are stored in which a note to be sounded at each sound production timing is set, and a performance is performed based on the performance pattern Pa, thereby performing automatic performance. At that time, among the stored performance patterns Pa, the performance may be switched to the performance pattern Pa matching a rhythm of depression/release of the key 2a performed by the performer. Based on velocity (strength) of depression of the key 2a, the volume of the performance pattern Pa being automatically performed is changed. Hereafter, the automatic performance based on the performance pattern Pa will simply be abbreviated as “automatic performance.”

First, switching of the performance pattern Pa is described. In the present embodiment, a rhythm is detected from depression/release of the key 2a and is compared with a preset rhythm pattern, the performance pattern Pa corresponding to a most similar rhythm pattern is acquired, and the performance is switched to this performance pattern Pa from the performance pattern Pa being performed.

In a rhythm pattern, a “note duration” being the duration of each sound arranged in one bar in 4/4 time, a “note spacing” being a time between each sound arranged and a sound produced immediately therebefore, and a “number of sounds” being the number of sounds arranged are set. A length of the rhythm pattern is set to up to one bar.

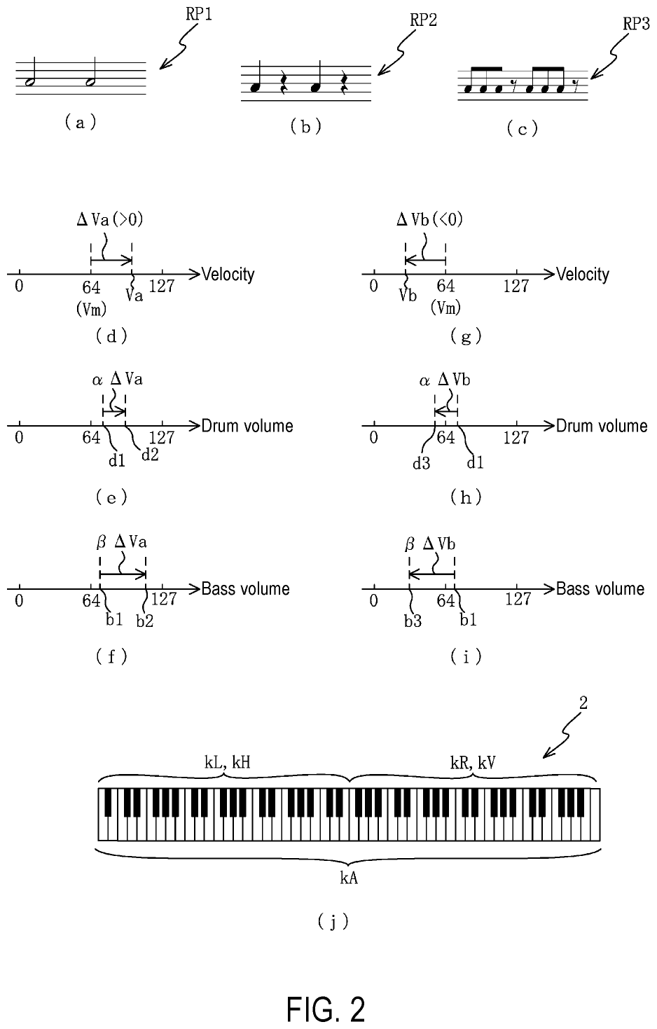

In the present embodiment, a plurality of rhythm patterns RP1 to RP3 and so on are provided, the rhythm detected from depression/release of the key 2a is compared with each rhythm pattern, and the most similar rhythm pattern is acquired. Referring to (a) to (c) of FIG. 2, the rhythm pattern is described using the rhythm patterns RP1 to RP3 as examples.

(a) to (c) of FIG. 2 are diagrams representing the rhythm patterns RP1 to RP3 respectively. As illustrated in (a) of FIG. 2, in the rhythm pattern RP1, two half notes are arranged in one bar. While the rhythm pattern RP1 is expressed by musical notes in (a) of FIG. 2, in actual data of the rhythm pattern RP1, the note duration of the first half note, the note duration of the second half note, the note spacing between the first and second half notes, and the number (that is, “2”) of sounds are set.

As illustrated in (b) of FIG. 2, in the rhythm pattern RP2, a quarter note and a quarter rest are alternately arranged in one bar; as illustrated in (c) of FIG. 2, in the rhythm pattern RP3, three consecutive eighth notes and one eighth rest are alternately arranged in one bar. Similarly to the rhythm pattern RP1, in the actual data of each of the rhythm patterns RP2 and RP3, the note duration, note spacing, and number of sounds arranged in one bar are set.

If the rhythm pattern includes a plurality of note durations or note spacings, the note durations or note spacings are set in order of their corresponding sounds appearing within one bar of the rhythm pattern. In the present embodiment, these combinations of note duration, note spacing, and number of sounds are used as indicators representing rhythm patterns or rhythms of depression/release of the key 2a.

Although musical notes are arranged at the position of “La” (A) in (a) to (c) of FIG. 2, the pitch of the depressed/released key 2a is not considered in the comparison between the rhythm detected from depression/release of the key 2a and the rhythm pattern in the present embodiment.

A plurality of rhythm patterns set in this way are compared with the rhythm detected from depression/release of the key 2a, that is, the note duration, note spacing, and number of sounds detected from depression/release of the key 2a, and the most similar rhythm pattern is acquired. Specifically, performance information outputted from the keyboard 2 is sequentially accumulated, and from note-on/note-off information in the performance information detected within a first period that is most recent, the note duration and note spacing of each sound and the number of sounds are acquired. In the present embodiment, “3 seconds” is set as the first period. However, the disclosure is not limited thereto, and the first period may be longer than or shorter than 3 seconds.

Among them, a time from note-on to note-off continuously at the same pitch detected within the most recent first period is acquired as the note duration. If a plurality of note-ons and note-offs continuously at the same pitch are detected within the most recent first period, each note duration is acquired in order of the detected note-ons and note-offs.

A time from a certain note-off to the next note-on detected within the most recent first period is acquired as the note spacing. Similarly to note duration, if a plurality of note-offs and note-ons are detected within the most recent first period, each note spacing is acquired in order of the detected note-offs and note-ons. The number of note-ons detected within the most recent first period is acquired as the number of sounds.

With respect to each of a plurality of rhythm patterns, a similarity representing how similar the note duration, note spacing, and number of sounds set in the rhythm pattern are to the note duration, note spacing, and number of sounds within the most recent first period is calculated. Specifically, first, a “score” for each of the note duration, note spacing, and number of sounds is acquired, and the similarity is calculated by summing up the acquired scores.

Among them, with respect to the score for the note duration, first, a difference between the note duration included in a rhythm pattern and the note duration acquired within the corresponding most recent first period is calculated. An integer of 1 to 5 is acquired as a score for the note duration in ascending order of absolute value of the calculated difference. In the present embodiment, if the absolute value of the difference in note duration is between 0 and 0.05 second, “5” is acquired as the score for the note duration; in the cases of between 0.05 and 0.1 second, between 0.1 and 0.15 second, between 0.15 and 0.2 second, and greater than 0.2 second, “4”, “3”, “2”, and “1”, respectively, are acquired as the respective scores for the note duration. If a rhythm pattern includes only one note duration, these scores are acquired as the score for the note duration of the rhythm pattern concerned.

On the other hand, if a rhythm pattern includes a plurality of note durations, the score mentioned above is acquired for each of the plurality of note durations, and an average value of the acquired scores is taken as the score for the note duration of the rhythm pattern concerned. Specifically, note durations are acquired in order from the rhythm pattern, while note durations acquired within the most recent first period are also acquired in order. Then, each score is acquired for the acquired note durations of the rhythm pattern and the note durations acquired within the most recent first period in the order corresponding to the aforementioned note durations. The average value of the acquired scores is taken as the score for the note duration of the rhythm pattern concerned.

For example, if a rhythm pattern includes three note durations, a score is acquired for the first note duration of this rhythm pattern and the first note duration acquired within the most recent first period. A score is acquired for the second note duration of the rhythm pattern and the second note duration acquired within the most recent first period, and a score is acquired for the third note duration of the rhythm pattern and the third note duration acquired within the most recent first period. An average value of the three scores thus acquired is taken as the score for the note duration of the rhythm pattern concerned.

With respect to the score for the note spacing, first, a difference between the note spacing included in a rhythm pattern and the note spacing within the corresponding most recent first period is calculated. An integer of 1 to 5 is acquired as a score for the note spacing in ascending order of absolute value of the calculated difference. If the absolute value of the difference in note spacing is between 0 and 0.05 second, “5” is acquired as the score for the note spacing; in the cases of between 0.05 and 0.1 second, between 0.1 and 0.15 second, between 0.15 and 0.2 second, and greater than 0.2 second, “4”, “3”, “2”, and “1”, respectively, are acquired as the respective scores for the note spacings. If a rhythm pattern includes only one note spacing, these scores are acquired as the score for the note spacing of the rhythm pattern concerned.

On the other hand, if a rhythm pattern includes a plurality of note spacings, similarly to the note duration mentioned above, the score mentioned above is acquired for each of the plurality of note spacings, and an average value of the acquired scores is taken as the score for the note spacing of the rhythm pattern concerned. Specifically, note spacings are acquired in order from the rhythm pattern, while note spacings acquired within the most recent first period are also acquired in order. Then, each score is acquired for the acquired note spacings of the rhythm pattern and the note spacings acquired within the most recent first period in the order corresponding to the aforementioned note spacings. The average value of the acquired scores is taken as the score for the note spacing of the rhythm pattern concerned.

With respect to the score for the number of sounds, a difference between the number of sounds included in a rhythm pattern and the number of sounds acquired within the most recent first period is calculated, and an integer of 1 to 5 is acquired as a score for the number of sounds in ascending order of absolute value of the calculated difference. If the absolute value of the difference in number of sounds is 0, “5” is acquired as the score for the number of sounds; in the cases of 1, 2, 3, and 4 or greater, “4”, “3”, “2”, and “1”, respectively, are acquired as the respective scores for the number of sounds of the rhythm pattern concerned.

Ranges of the absolute value of the difference in note duration or note spacing corresponding to the scores for the note duration or note spacing or values of the scores for the note duration or note spacing are not limited to those mentioned above. Other ranges may be set for the absolute value of the difference in note duration or note spacing, or other values may be set for the scores for the note duration or note spacing. Similarly, ranges of the absolute value of the difference in number of sounds corresponding to the scores for the number of sounds or values of the scores for the number of sounds are not limited to those mentioned above. Other ranges may be set for the absolute value of the difference in number of sounds, or other values may be set for the scores for the number of sounds.

A sum total of the scores for the note duration, note spacing and number of sounds thus acquired is calculated as a similarity of the rhythm pattern concerned. The similarity is calculated similarly for all of a plurality of rhythm patterns. Then, among the plurality of rhythm patterns, a rhythm pattern having highest similarity is acquired as a rhythm pattern most similar to the rhythm of depression/release of the key 2a acquired within the most recent first period.

Then, the performance pattern Pa corresponding to the most similar rhythm pattern acquired is acquired, and the performance is switched to this performance pattern Pa from the performance pattern Pa being performed. Accordingly, without the performer interrupting performance by letting go their hand from the keyboard 2 they have been playing and operating the setting button 3 or the like, it is possible to automatically switch to the performance pattern Pa suitable for a rhythm of the performance of the keyboard 2.

Next, changing the volume of the performance pattern Pa to be automatically performed is described. In the present embodiment, the volume of the performance pattern Pa is changed based on the velocity at the time of depression of the key 2a. More specifically, the performance pattern Pa includes a plurality of performance parts such as drum, bass, and accompaniment (musical instrument having a pitch), and the volume is changed based on the velocity at the time of depression of the key 2a for each performance part.

First, similarly to the switching of the performance pattern Pa mentioned above, the performance information outputted from the keyboard 2 is sequentially accumulated, and each velocity in the performance information acquired within a second period that is most recent is acquired. Then, an average value V of the acquired velocities is calculated. In the present embodiment, “3 seconds” is set as the second period, like the first period. However, the disclosure is not limited thereto, and the second period may be longer than or shorter than 3 seconds.

A differential value ΔV is calculated which is a value obtained by subtracting an intermediate value Vm of the velocity from the calculated average value V. The intermediate value Vm of the velocity is a reference value serving as a reference in calculating the differential value ΔV. In the present embodiment, an intermediate value “64” between a maximum possible value “127” and a minimum possible value “0” of the velocity is set as the intermediate value V. The intermediate value here refers to a value obtained by dividing, by 2, a sum of the maximum and minimum possible values of the velocity, or a value in the vicinity thereof, and may be expressed as an “approximately intermediate value”.

A value obtained by multiplying the calculated differential value ΔV by a weight coefficient set for each performance part is added to a set value of the volume of each performance part, and a result thereof is taken as the volume of each performance part after change. Changing of the volume of the performance pattern Pa is described with reference to (d) to (i) of FIG. 2.

(d) of FIG. 2 is a diagram representing a case where the average value V of the velocity is greater than the intermediate value Vm of the velocity. (e) of FIG. 2 is a diagram representing a change in drum volume in the case where the average value V of the velocity is greater than the intermediate value Vm of the velocity. (f) of FIG. 2 is a diagram representing a change in bass volume in the case where the average value V of the velocity is greater than the intermediate value Vm of the velocity.

As illustrated in (d) of FIG. 2, if an average value Va of the velocity is greater than the intermediate value Vm of the velocity, a differential value ΔVa between the average value Va of the velocity and the intermediate value Vm of the velocity is a positive value. A value obtained by multiplying such a positive differential value ΔVa by the weight coefficient for each performance part is taken as a change amount of the volume of each performance part. A result obtained by adding the calculated change amount of the volume to the set value of the volume of each performance part is taken as the volume of each performance part after change. In the present embodiment, the set value of the volume of each performance part is set by the setting button 3.

In the present embodiment, the weight coefficient is set in advance by the performer via the setting button 3 for each performance pattern Pa and each performance part of the performance pattern Pa. In particular, if the weight coefficient for a certain performance part is set to 0, the volume of this performance part can be kept constant (that is, kept at the set value of the volume) regardless of the average velocity V. Weight coefficients such as α and β may have the same value regardless of the performance pattern Pa and the performance part.

In the present embodiment, the set value of the volume is set in advance by the performer via the setting button 3 for each performance pattern Pa and each performance part. The set value of the volume may be the same volume regardless of the performance pattern Pa and the performance part.

For example, as illustrated in (e) of FIG. 2, a change amount of the volume of the drum among the performance parts is taken as αΔVa, which is obtained by multiplying the differential value ΔVa by the weight coefficient α (where α>0) of the drum. Volume d2, which is a result obtained by adding the change αΔVa in volume to a set value d1 of the drum volume, is taken as the drum volume after change.

Similarly, as illustrated in (f) of FIG. 2, a change amount of the volume of the bass among the performance parts is taken as βΔVa, which is obtained by multiplying the differential value ΔVa by the weight coefficient β of the bass. In the present embodiment, the weight coefficient β (where β>0) is set to a greater value than the weight coefficient α of the drum mentioned above. Volume b2, which is a result obtained by adding the change βΔVa in volume to a set value b1 of the bass volume, is taken as the bass volume after change.

In the present embodiment, the weight coefficient such as α and β is set in advance for each performance pattern Pa and each performance part of the performance pattern Pa. The weight coefficient such as α and β may be set to the same coefficient regardless of the performance pattern Pa and the performance part, or the performer may be allowed to set the weight coefficient arbitrarily via the setting button 3. The weight coefficient is set to a positive value but is not limited thereto. Rather, the weight coefficient may be set to a negative value.

In (d) to (f) of FIG. 2, since the differential value ΔVa is a positive value, and furthermore, the weight coefficients α and β are each a positive value, the volume d2 of the drum after change and the volume b2 of the bass after change are respectively greater than the set value d1 of the drum volume and the set value b1 of the bass volume. That is, in the case where the key 2a is continuously strongly struck due to the liveliness of the performer's performance, the volume of the performance pattern Pa is accordingly increased. By the performance pattern Pa in which the volume varies in this way, the performer's performance can be livened up.

Next, a case is described where the differential value ΔV is negative. (g) of FIG. 2 is a diagram representing a case where the average value V of the velocity is less than the intermediate value Vm of the velocity. (h) of FIG. 2 is a diagram representing a change in drum volume in the case where the average value V of the velocity is less than the intermediate value Vm of the velocity. (i) of FIG. 2 is a diagram representing a change in bass volume in the case where the average value V of the velocity is less than the intermediate value Vm of the velocity.

As illustrated in (g) of FIG. 2, if an average value Vb of the velocity is less than the intermediate value Vm of the velocity, a differential value ΔVb between the average value Vb of the velocity and the intermediate value Vm of the velocity is a negative value.

As illustrated in (h) of FIG. 2, a change amount of the drum volume is taken as αΔVb, which is obtained by multiplying the differential value ΔVb by the weight coefficient α. Volume d3, which is a result obtained by adding the change αΔVb in volume to the set value d1 of the drum volume, is taken as the drum volume after change. Similarly, as illustrated in (i) of FIG. 2, a change amount of the volume of the bass among the performance parts is taken as βΔVb, which is obtained by multiplying the differential value ΔVb by the weight coefficient β. Volume b3, which is a result obtained by adding the change βΔVb in volume to the set value b1 of the bass volume, is taken as the bass volume after change.

In (g) to (i) of FIG. 2, since the differential value ΔVb is a negative value, and furthermore, the weight coefficients α and β are each a positive value, the volume d3 of the drum after change and the volume b3 of the bass after change are respectively less than the set value d1 of the drum volume and the set value b1 of the bass volume. That is, in the case where the key 2a is continuously weakly struck for delicate expression in the performance by the performer, the volume of the performance pattern Pa is accordingly decreased. Accordingly, the performance pattern Pa matching a delicate performance by the performer without hindering the performance can be automatically performed.

In the present embodiment, the volume of each performance part is obtained by adding a value based on the differential value ΔV of the velocity to the set value of the volume. That is, since the volume of each performance part changes according to whether the differential value ΔV is positive or negative relative to the set value of the volume and the magnitude of the differential value ΔV, it is prevented that the volume of each performance part differs markedly from the set value of the volume. Thus, a balance of volume between the performance parts in the performance pattern Pa can be maintained close to a balance between the set values of the volume set in advance for each performance part. Accordingly, discomfort experienced by a listener in the case where the volume of each performance part in the performance pattern Pa is changed based on the velocity at the time of depression of the key 2a may be reduced.

By varying the weight coefficient for each performance part, the change amount of the volume can be varied for each performance part. Accordingly, a uniform change in volume of each performance part of the performance pattern Pa can be reduced, and automatic performance full of variety and expression can be realized.

As described above, in the present embodiment, the performance pattern Pa is switched according to the rhythm of depression/release of the key 2a, and the volume of the performance pattern Pa is changed according to the velocity at the time of depression of the key 2a. Furthermore, it is possible to set a range of the key 2a on the keyboard 2 in which performance information used for switching the performance pattern Pa is outputted and a range of the key 2a on the keyboard 2 in which performance information used for changing the volume of the performance pattern Pa is outputted. Hereinafter, a sequential range of the keys 2a on the keyboard 2 is referred to as a “key range”.

(j) of FIG. 2 is a diagram representing a key range on the keyboard 2. Specifically, the key ranges mainly provided include a key range kA including all the keys 2a provided on the keyboard 2, a key range kL composed of a range from the key 2a corresponding to a lowest tone to the key 2a corresponding to a tone near the middle of the keyboard 2, and a key range kR including the keys 2a having a higher tone than those in the key range kL.

Among them, the key range kL corresponds to the left-hand part played by the performer with their left hand. On the other hand, the key range kR corresponds to the right-hand part played by the performer with their right hand. In the present embodiment, the key range kL is set as a rhythm key range kH used for switching the performance pattern Pa.

Here, the key range kL is a key range corresponding to the left-hand part played by the performer. The left-hand part mainly performs an accompaniment, and a rhythm is generated by the accompaniment. By detecting a rhythm from performance information on the key range kL corresponding to such a left-hand part, and switching the performance pattern Pa based on the rhythm, the performance pattern Pa matching the rhythm in the performer's performance can be automatically performed.

On the other hand, the key range kR is set as a velocity key range kV used for changing the volume of the performance pattern Pa. Here, the key range kR is a key range corresponding to the right-hand part played by the performer, and the right-hand part mainly performs a main melody. By detecting a velocity from performance information on the key range kR in which the main melody is performed in this way, and changing the volume of the performance pattern Pa based on the velocity, the performance pattern Pa having a volume matching intonation of the main melody of the performance can be automatically performed.

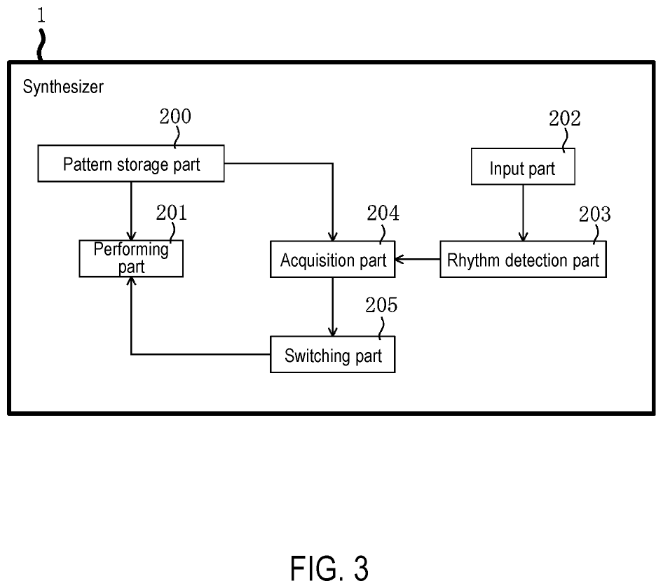

Next, a function of the synthesizer 1 is described with reference to FIG. 3. FIG. 3 is a functional block diagram of the synthesizer 1. As illustrated in FIG. 3, the synthesizer 1 includes a pattern storage part 200, a performing part 201, an input part 202, a rhythm detection part 203, an acquisition part 204, and a switching part 205.

The pattern storage part 200 is a means of storing a plurality of performance patterns, and is realized by a style table 11c described later in FIG. 4. The performing part 201 is a means of performing a performance based on a performance pattern stored in the pattern storage part 200, and is realized by the CPU 10 described later in FIG. 4. The input part 202 is a means of inputting performance information from an input device, and is realized by the CPU 10. The input device is realized by the keyboard 2.

The rhythm detection part 203 is a means of detecting a rhythm from the performance information inputted by the input part 202, and is realized by the CPU 10. The acquisition part 204 is a means of acquiring a performance pattern corresponding to the rhythm detected by the rhythm detection part 203 from among the plurality of performance patterns stored in the pattern storage part 200, and is realized by the CPU 10. The switching part 205 is a means of switching a performance pattern being performed by the performing part 201 to the performance pattern acquired by the acquisition part 204, and is realized by the CPU 10.

A performance pattern is acquired based on the rhythm detected from the inputted performance information, and the acquired performance pattern is switched to a performance pattern being performed. This enables automatic switching to a performance pattern suitable for a performer's performance without interrupting the performance.

Next, an electrical configuration of the synthesizer 1 is described with reference to FIG. 4. (a) of FIG. 4 is a block diagram illustrating the electrical configuration of the synthesizer 1. The synthesizer 1 includes the CPU 10, a flash ROM 11, a RAM 12, the keyboard 2 and the setting button 3 mentioned above, a sound source 13, and a digital signal processor (DSP) 14, each of which is connected via a bus line 15. A digital-to-analog converter (DAC) 16 is connected to the DSP 14, an amplifier 17 is connected to the DAC 16, and a speaker 18 is connected to the amplifier 17.

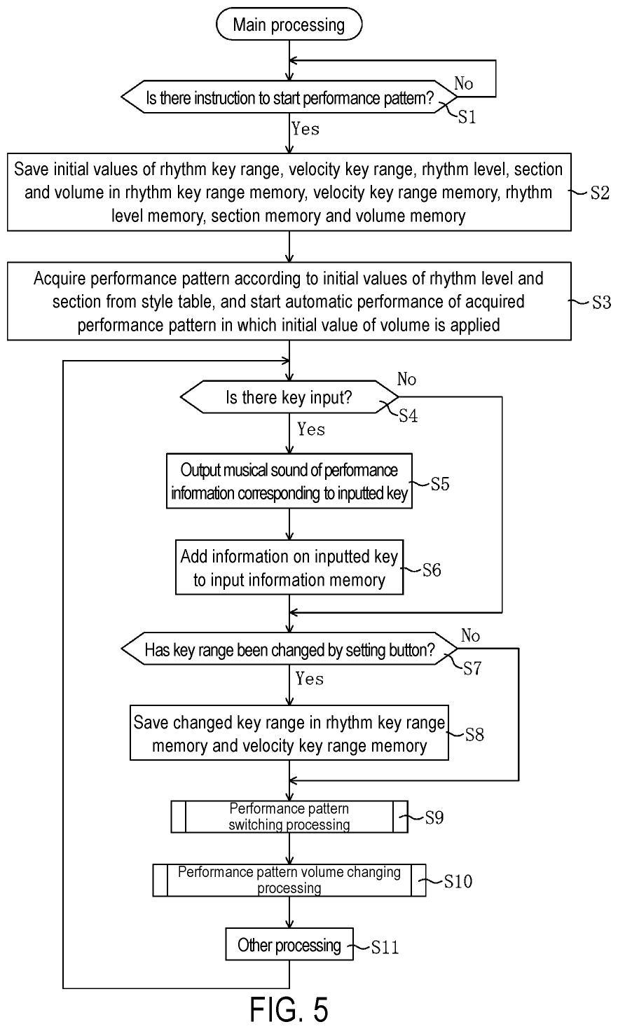

The CPU 10 is an arithmetic unit that controls each part connected by the bus line 15. The flash ROM 11 is a rewritable non-volatile memory, and includes a control program 11a, a rhythm table 11b, and the style table 11c. When the control program 11a is executed by the CPU 10, main processing of FIG. 5 is executed. The rhythm table 11b is a data table in which the rhythm pattern mentioned above is stored. The style table 11c is a data table in which the performance pattern Pa mentioned above is stored. The rhythm table 11b and the style table 11c are described with reference to (b) and (c) of FIG. 4.

(b) of FIG. 4 is a schematic diagram of the rhythm table 11b. In the rhythm table 11b, a rhythm level (L1, L2, . . . ) representing complexity of a rhythm and a rhythm pattern (RP1, RP2, RP3, . . . ) corresponding to the rhythm level are stored in association.

The “complexity of a rhythm” is set according to a time interval between sounds arranged in one bar or irregularity of the sounds arranged in one bar. For example, the shorter the time interval between the sounds arranged in one bar, the more complex the rhythm; the longer the time interval between the sounds arranged in one bar, the simpler the rhythm. The more irregularly the sounds are arranged in one bar, the more complex the rhythm; the more regularly the sounds are arranged in one bar, the simpler the rhythm. The rhythm levels are set in order of simplicity of the rhythm as level L1, level L2, level L3, and so on. The note duration, note spacing and number of sounds mentioned above are stored in the rhythm pattern in the rhythm table 11b.

Although detailed later, in switching the performance pattern Pa, a similarity between a detected rhythm of depression/release of the key 2a and all the rhythm patterns stored in the rhythm table 11b is calculated, and a rhythm level corresponding to the most similar rhythm pattern is acquired.

(c) of FIG. 4 is a schematic diagram of the style table 11c. In the style table 11c, the performance pattern Pa corresponding to each rhythm level mentioned above is stored for each rhythm level. The performance pattern Pa is further set for each section representing a stage of a musical piece, such as an intro, a main section (such as main 1 and main 2), and an ending.

For example, performance pattern Pa_L1_i for the intro, performance pattern Pa_L1_m1 for main 1, performance pattern Pa_L1_e for the ending and so on are stored as the performance pattern Pa corresponding to level L1 in the style table 11c. Similarly, for levels L2 and L3 and other rhythm levels, the performance pattern Pa is stored for each section.

Although detailed later, the performance pattern Pa corresponding to a rhythm level acquired based on the rhythm of depression/release of the key 2a and a section set via the setting button 3 is acquired from the style table 11c, and the performance pattern Pa being automatically performed is switched to the acquired performance pattern Pa.

Please refer back to (a) of FIG. 4. The RAM 12 is a memory rewritably storing various work data or flags or the like when the CPU 10 executes a program such as the control program 11a. The RAM 12 includes a rhythm key range memory 12a in which the rhythm key range kH mentioned above is stored, a velocity key range memory 12b in which the velocity key range kV mentioned above is stored, an input information memory 12c, a rhythm level memory 12d in which the rhythm level mentioned above is stored, a section memory 12e in which the section mentioned above is stored, and a volume memory 12f in which the volume of each performance part of the performance pattern Pa is stored.

In the input information memory 12c, information obtained by combining performance information inputted from the keyboard 2 with a time when this performance information was inputted is stored in order of input of the performance information. In the present embodiment, the input information memory 12c is composed of a ring buffer, and is configured to be able to store information obtained by combining performance information with a time when this performance information was inputted within the most recent first period (second period). The information obtained by combining performance information with a time when this performance information was inputted is hereinafter referred to as “input information”.

The sound source 13 is a device that outputs waveform data according to the performance information inputted from the CPU 10. The DSP 14 is an arithmetic unit for arithmetically processing the waveform data inputted from the sound source 13. The DAC 16 is a conversion device that converts the waveform data inputted from the DSP 14 into analog waveform data. The amplifier 17 is an amplification device that amplifies the analog waveform data outputted from the DAC 16 with a predetermined gain. The speaker 18 is an output device that emits (outputs) the analog waveform data amplified by the amplifier 17 as a musical sound.

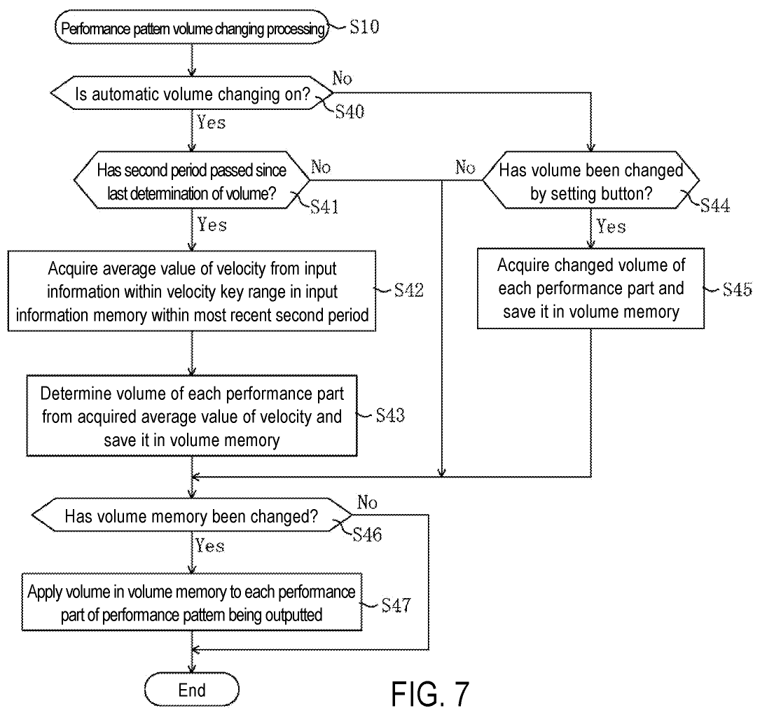

Next, main processing executed by the CPU 10 is described with reference to FIG. 5 to FIG. 7. FIG. 7 is a flowchart of the main processing. The main processing is processing executed when power of the synthesizer 1 is turned on.

In the main processing, first, it is confirmed whether there has been an instruction from the performer via the setting button 3 to start automatic performance of the performance pattern Pa (S1). In the processing of S1, if there has been no instruction to start automatic performance of the performance pattern Pa (S1: No), the processing of S1 is repeated. On the other hand, in the processing of S1, if there has been an instruction to start automatic performance of the performance pattern Pa (S1: Yes), initial values of rhythm key range kH, velocity key range kV, rhythm level, section, and volume of each performance part of the performance pattern Pa are set in the rhythm key range memory 12a, the velocity key range memory 12b, the rhythm level memory 12d, the section memory 12e, and the volume memory 12f, respectively (S2).

Specifically, the key range kL (see (j) of FIG. 2) is set in the rhythm key range memory 12a, the key range kR (see (j) of FIG. 2) is set in the velocity key range memory 12b, level L1 is set in the rhythm level memory 12d, intro is set in the section memory 12e, and a value set by the setting button 3 is acquired and set as the initial value of the volume of each performance part in the volume memory 12f. The initial values set in each memory in the processing of S2 are not limited to those mentioned above, and other values may be set.

After the processing of S2, the performance pattern Pa according to the initial values of the rhythm level in the rhythm level memory 12d and the section in the section memory 12e is acquired from the style table 11c. Automatic performance of the acquired performance pattern Pa in which the initial value of the volume of each performance part in the volume memory 12f is applied to the volume of each performance part of the acquired performance pattern Pa is started (S3).

After the processing of S3, it is confirmed whether there has been a key input, that is, whether performance information from the key 2a has been inputted (S4). In the processing of S4, if the performance information from the key 2a has been inputted (S4: Yes), a musical sound corresponding to the inputted performance information is outputted (S5). Specifically, the inputted performance information is outputted to the sound source 13, waveform data corresponding to the inputted performance information is acquired in the sound source 13, and the waveform data is outputted as the musical sound via the DSP 14, the DAC 16, the amplifier 17 and the speaker 18. Accordingly, a musical sound according to the performer's performance is outputted.

After the processing of S5, the inputted performance information and a time when this performance information was inputted are added as input information to the input information memory 12c (S6). In the processing of S4, if the performance information from the key 2a has not been inputted (S4: No), the processing of S5 and S6 is skipped.

After the processing of S4 and S6, it is confirmed whether the rhythm key range kH or the velocity key range kV has been changed by the performer via the setting button 3 (S7). In the processing of S7, if the rhythm key range kH or the velocity key range kV has been changed (S7: Yes), the changed rhythm key range kH or velocity key range kV is saved in the corresponding rhythm key range memory 12a or velocity key range memory 12b (S8). On the other hand, if neither the rhythm key range kH nor the velocity key range kV has been changed (S7: No), the processing of S8 is skipped.

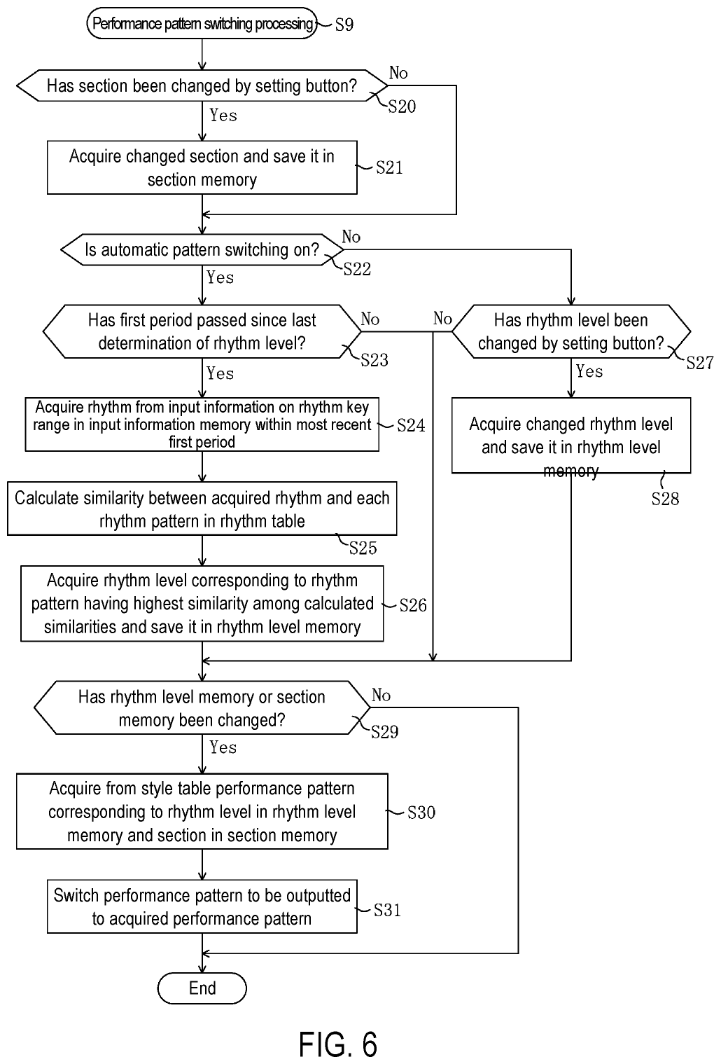

After the processing of S7 and S8, performance pattern switching processing (S9) and performance pattern volume changing processing (S10) described later with reference to FIG. 6 and FIG. 7 are executed. After the performance pattern volume changing processing of S10, other processing (S11) of the synthesizer 1 is executed, and the processing of S4 onward is repeated. Here, the performance pattern switching processing of S9 and the performance pattern volume changing processing of S10 are described with reference to FIG. 6 and FIG. 7.

FIG. 6 is a flowchart of the performance pattern switching processing. In the performance pattern switching processing, first, it is confirmed whether the section has been changed by the performer via the setting button 3 (S20). In the processing of S20, if the section has been changed (S20: Yes), the changed section is acquired and saved in the section memory 12e (S21). Accordingly, the section set by the setting button 3 is stored in the section memory 12e taking into account the stage being performed by the performer. The stored section is reflected in the performance pattern Pa to be automatically performed by the processing of S30 and S31 described later.

On the other hand, in the processing of S20, if the section has not been changed (S20: No), the processing of S21 is skipped. After the processing of S20 and S21, it is confirmed whether automatic pattern switching is on (S22). The automatic pattern switching is a setting of whether to switch the performance pattern Pa based on the rhythm of depression/release of the key 2a mentioned above in FIG. 2. If the automatic pattern switching is on, the performance pattern Pa may be switched according to the rhythm detected from depression/release of the key 2a. On the other hand, if the automatic pattern switching is off, the performance may be switched to the performance pattern Pa corresponding to the rhythm level set by the performer via the setting button 3.

In the processing of S22, if the automatic pattern switching is on (S22: Yes), it is confirmed whether a first period has passed since the last determination of rhythm level by the processing of S24 to S26 (described later in detail) (S23). In the processing of S23, if the first period has passed since the last determination of rhythm level (S23: Yes), a rhythm is acquired from the input information in the input information memory 12c within the most recent first period, which is input information of performance information corresponding to the rhythm key range kH in the rhythm key range memory 12a (S24).

Specifically, in the processing of S24, the input information within the most recent first period is acquired from the input information memory 12c. In the acquired input information, the input information of performance information corresponding to the rhythm key range kH is further acquired. From the acquired input information, the rhythm, that is, note duration, note spacing and number of sounds, are acquired by the method mentioned above in FIG. 2.

After the processing of S24, a similarity between the rhythm acquired in the processing of S24 and each rhythm pattern in the rhythm table 11b is calculated (S25). Specifically, as mentioned above in FIG. 2, the scores for the note duration, note spacing and number of sounds for each rhythm pattern stored in the rhythm table 11b and the scores for the note duration, note spacing and number of sounds acquired in the processing of S24 are respectively acquired. By summing up the scores for the note duration, note spacing and number of sounds acquired for each rhythm pattern, a similarity for each rhythm pattern is calculated.

After the processing of S25, a rhythm level corresponding to a rhythm pattern having the highest similarity among the calculated similarities for each rhythm pattern is acquired from the rhythm table 11b and saved in the rhythm level memory 12d (S26). Accordingly, a rhythm level corresponding to a rhythm pattern most similar to the rhythm detected from depression/release of the key 2a within the most recent first period is saved in the rhythm level memory 12d.

In the processing of S23, if the first period has not passed since the last determination of rhythm level (S23: No), the processing of S24 to S26 is skipped.

In the processing of S22, if the automatic pattern switching is off (S22: No), it is confirmed whether the rhythm level has been changed by the performer via the setting button 3 (S27). In the processing of S27, if the rhythm level has been changed by the performer (S27: Yes), the changed rhythm level is saved in the rhythm level memory 12d (S28). On the other hand, in the processing of S27, if the rhythm level has not been changed by the performer (S27: No), the processing of S28 is skipped.

After the processing of S23 and S26 to S28, it is confirmed whether the value in the rhythm level memory 12d or the section memory 12e has been changed by the processing of S20 to S28 (S29). In the processing of S29, if it is confirmed that the value in the rhythm level memory 12d or the section memory 12e has been changed (S29: Yes), the performance pattern Pa corresponding to the rhythm level in the rhythm level memory 12d and the section in the section memory 12e is acquired from the style table 11c (S30).

After the processing of S30, the performance pattern Pa to be outputted for performing automatic performance is switched to the performance pattern Pa acquired in the processing of S30 (S31). If the switching to the performance pattern Pa is performed by the processing of S31, automatic performance according to the performance pattern Pa acquired in the processing of S30 is started after automatic performance according to the performance pattern Pa before switching has been performed until its end. Accordingly, switching from a performance pattern Pa being automatically performed to another performance pattern Pa in the middle of the automatic performance is prevented. Thus, the listener may experience less discomfort with respect to switching of the performance pattern Pa.

In the processing of S29, if it is confirmed that neither the value in the rhythm level memory 12d nor the value in the section memory 12e has been changed (S29: No), the processing of S30 and S31 is skipped. After the processing of S29 and S31, the performance pattern switching processing is ended.

FIG. 7 is a flowchart of the performance pattern volume changing processing. In the performance pattern volume changing processing, first, it is confirmed whether automatic volume changing is on (S40). The automatic volume changing is a setting of whether to change the volume of each performance part of the performance pattern Pa according to the velocity detected from depression/release of the key 2a mentioned above in FIG. 2. If the automatic volume changing is on, the volume of each performance part may be switched based on the velocity at the time of depression of the key 2a. On the other hand, if the automatic volume changing is off, the volume of each performance part may be changed to the volume set by the performer via the setting button 3.

In the processing of S40, if the automatic volume changing is on (S40: Yes), it is confirmed whether a second period has passed since the last time the processing of S42 and S43 (described later in detail) was performed, that is, the last determination of volume (S41). In the processing of S41, if the second period has passed since the last determination of volume (S41: Yes), the average value V of the velocity is acquired from the input information in the input information memory 12c within the most recent second period, which is input information of performance information corresponding to the velocity key range kV in the velocity key range memory 12b (S42).

Specifically, in the processing of S42, the input information within the most recent second period is acquired from the input information memory 12c. In the acquired input information, the input information of performance information corresponding to the velocity key range kV is further acquired. Each velocity is acquired from the performance information in the acquired input information. By averaging the acquired velocities, the average value V of the velocity is acquired.

After the processing of S42, the volume of each performance part is determined from the acquired average value V of the velocity and is saved in the volume memory 12f (S43). Specifically, as mentioned above in FIG. 2, the differential value ΔV is calculated by subtracting the intermediate value Vm of the velocity from the average value V of the velocity, and a change amount is calculated by multiplying the calculated differential value ΔV by the weight coefficient (α, β or the like in FIG. 2) for each performance part.

A set value of the volume set by the setting button 3 is acquired for each performance part. By adding the calculated change amount for each performance part to each acquired set value of the volume, the volume after change of each performance part is calculated. Each calculated volume after change is saved in the volume memory 12f. Accordingly, the volume of each performance part of the performance pattern Pa set according to the velocity of depression/release of the key 2a is saved in the volume memory 12f.

In the processing of S41, if the second period has not passed since the last determination of volume (S41: No), the processing of S42 and S43 is skipped. In the processing of S40, if the automatic volume changing is off (S40: No), it is confirmed whether the volume of any of the performance parts of the performance pattern Pa has been changed by the performer via the setting button 3 (S44).

In the processing of S44, if the volume of any of the performance parts has been changed (S44: Yes), the changed volume of the performance part is saved in the volume memory 12f (S45). On the other hand, in the processing of S44, if no change has occurred in the volume of any performance part (S44: No), the processing of S45 is skipped.

After the processing of S41 and S43 to S45, it is confirmed whether the value in the volume memory 12f has been changed by the processing of S40 to S45 (S46). In the processing of S46, if it is confirmed that the value in the volume memory 12f has been changed (S46: Yes), the volume of each performance part in the volume memory 12f is applied to the volume of each performance part of the performance pattern Pa being automatically performed (S47).

At this time, the volume after change is immediately applied to each performance part of the performance pattern Pa being automatically performed. Accordingly, the volume of the performance pattern Pa can be changed following a change in the velocity at the time of depression of the key 2a. Thus, automatic performance is made possible of the performance pattern Pa having an appropriate volume that follows the liveliness or delicateness of the performer's performance.

On the other hand, if it is confirmed in the processing of S46 that the value in the volume memory 12f has not been changed (S46: No), the processing of S47 is skipped. After the processing of S46 and S47, the performance pattern volume changing processing is ended.

Although the disclosure has been described above based on the above embodiments, it can be easily inferred that various improvements or modifications may be made.

In the above embodiments, the rhythm level such as level L1 and level L2 is acquired according to the rhythm of depression/release of the key 2a in the processing of S24 to S26 of FIG. 6. However, the disclosure is not limited thereto. The rhythm level may be acquired according to other information related to depression/release of the key 2a, such as, for example, the velocity at the time of depression of the key 2a. In this case, it suffices if level L1, level L2 and so on are acquired in ascending order of velocity.

Accordingly, the rhythm level is acquired in which the greater the velocity at the time of depression of the key 2a, the more complex the rhythm. Thus, in the case of a lively performance having a great velocity at the time of depression of the key 2a, it is possible to output automatic performance of the performance pattern Pa corresponding to a complex rhythm so as to spur this performance. On the other hand, in the case of a delicate performance having a small velocity at the time of depression of the key 2a, it is possible to output automatic performance of the performance pattern Pa corresponding to a simple rhythm that does not destroy the atmosphere of this performance.

In the above embodiments, in the processing of S43 of FIG. 7, the volume of each performance part after change is set using the differential value ΔV of the velocity. However, the disclosure is not limited thereto. For example, the volume of each performance part after change may be set according to the rhythm of depression/release of the key 2a instead of the differential value ΔV of the velocity. Specifically, a rhythm level is acquired based on the rhythm of depression/release of the key 2a, and a numerical value corresponding to the rhythm level is acquired. By multiplying the numerical value by a weight coefficient and adding the product thereof to the set value of the volume of each performance part, the volume of each performance part after change may be calculated.

In this case, it suffices if the simpler the rhythm, the smaller the value is set for the “numerical value corresponding to the rhythm level”, and the more complex the rhythm, the greater the value is set for the “numerical value corresponding to the rhythm level”. For example, “−5” may be set as the “numerical value corresponding to the rhythm level” for level L1 at which the rhythm is simplest, “0” for level L2, and “5” for level L3.

Accordingly, in the case of a lively performance having a fast rhythm in which depression/release of the key 2a is repeated quickly, it is possible to output automatic performance of the performance pattern Pa having a loud volume so as to spur this performance. On the other hand, in the case of a delicate performance having a slow rhythm in which the key 2a is slowly depressed/released, it is possible to output automatic performance of the performance pattern Pa having a small volume that does not destroy the atmosphere of this performance.

In setting the volume of each performance part after change, both the differential value ΔV of the velocity and the rhythm of depression/release of the key 2a may be used. It is also possible to mix a performance part in which the volume after change is set using only the differential value ΔV of the velocity, a performance part in which the volume after change is set using only the rhythm of depression/release of the key 2a, and a performance part in which the volume after change is set using both the differential value ΔV of the velocity and the rhythm of depression/release of the key 2a.

In the above embodiments, in (d) and (g) of FIG. 2, the intermediate value Vm of the velocity is set as the reference value serving as a reference in calculating the differential value ΔV. However, the disclosure is not limited thereto. For example, the reference value may be the maximum possible value or the minimum possible value of the velocity, or may be any value between the maximum value and the minimum value. The reference value may be changed for each section in the section memory 12e or for each performing pattern Pa being automatically performed.

In the above embodiments, in (a) to (c) of FIG. 2, the length of the rhythm pattern is set to one bar in 4/4 time. However, the disclosure is not limited thereto. The length of the rhythm pattern may be one bar or more or one bar or less. The time serving as a reference of one bar for the length of the rhythm pattern is not limited to 4/4 time, and may be other times such as 3/4 time or 2/4 time. The time unit used for the rhythm pattern is not limited to a bar, and may be other time units such as a second or minute, or a tick value.

In the above embodiments, there is no definition of a tempo for the rhythm pattern. However, the disclosure is not limited thereto. For example, an initial value of the tempo of the rhythm pattern may be set to 120 beats per minute (BPM), and the performer may be allowed to change the tempo of the rhythm pattern using the setting button 3. If the tempo is changed, it suffices if an actual time length of the musical notes and rests included in the rhythm pattern is corrected accordingly.

In the above embodiments, in the processing of S25 of FIG. 6, the rhythm pattern most similar to the rhythm detected from depression/release of the key 2a is acquired using the similarity based on the scores for the note duration, note spacing, and number of sounds. However, the disclosure is not limited thereto. The rhythm pattern most similar to the rhythm detected from depression/release of the key 2a may be acquired using other indicators besides the similarity.

The indicator representing the rhythm or the similarity is not limited to being calculated based on note duration, note spacing, and number of sounds. For example, the indicator or the similarity may be calculated based on note duration and note spacing, or may be calculated based on note duration and number of sounds, or may be calculated based on note spacing and number of sounds, or may be calculated based on only one of note duration, note spacing and number of sounds. The similarity may be calculated based on note duration, note spacing, number of sounds, and other indicators representing the rhythm.

In the above embodiments, note duration and note spacing are set in the amount corresponding to the sounds included in the rhythm pattern. However, the disclosure is not limited thereto. For example, it is possible to set only average values of note durations and note spacings of the sounds included in the rhythm pattern. In this case, in calculating the similarity, similarities may be respectively calculated between the average values of note durations and note spacings detected from depression/release of the key 2a within the most recent first period and the average values of note durations and note spacings set in the rhythm pattern. Instead of the average values, other values such as maximum values, minimum values or intermediate values of the note durations and note spacings may be used. Furthermore, the average value of note durations and the maximum value of note spacings may be set, or the minimum value of note durations and the average value of note spacings may be set in the rhythm pattern.

In the above embodiments, in the case where a plurality of note durations or note spacings are included in the rhythm pattern, the average value of the individually acquired scores for note duration or note spacing is taken as the score for note duration or note spacing. However, the disclosure is not limited thereto. Other values such as the maximum value or the minimum value or the intermediate value of the individually acquired scores for note duration or note spacing may also be taken as the score for note duration or note spacing.

In the above embodiments, the similarity is the sum total of the scores for note duration, scores for note spacing and scores for number of sounds. However, the disclosure is not limited thereto. For example, the scores for note duration, note spacing and number of sounds may each be multiplied by a weight coefficient, and the similarity may be a sum total of the scores obtained by multiplication by the weight coefficient. In this case, the weight coefficient for each of note duration, note spacing and number of sounds may be varied according to the section in the section memory 12e.

Accordingly, when acquiring the rhythm pattern most similar to the rhythm detected from depression/release of the key 2a, it is possible to vary which indicator among note duration, note spacing, and number of sounds is to be emphasized for each section. Thus, automatic performance of the performance pattern Pa in a mode relatively matching the section is possible.

In the above embodiments, the performer manually changes the section with the setting button 3 by the processing of S20 and S21 of FIG. 6. However, the disclosure is not limited thereto. For example, the section may be automatically changed. In this case, when the performance pattern Pa corresponding to “intro” is automatically performed until the end, the performance pattern Pa corresponding to “main 1” is automatically performed until the end, the performance pattern Pa corresponding to “main 2” is automatically performed until the end, and so on. Finally, the performance pattern Pa corresponding to “ending” is automatically performed until the end, and the automatic performance may be ended.

Alternatively, a program of sections to be switched may be stored in advance (for example, intro→main 1→main 2 performed twice→main 1 performed three times→ . . . ending), and automatic performance of the performance patterns Pa of the corresponding sections may be performed in the order stored.

In the above embodiments, the first period and the second period are set to the same time. However, the disclosure is not limited thereto. The first period and the second period may be set as different times. In the processing of S24 of FIG. 6, the input information from which the rhythm is acquired is the input information in the input information memory 12c within the most recent first period. However, the disclosure is not limited thereto. For example, the input information from which the rhythm is acquired may be the input information in the input information memory 12c within a shorter period than the most recent first period or the input information in the input information memory 12c within a longer period than the most recent first period.

Similarly, in the processing of S42 of FIG. 7, the input information from which the velocity is acquired is the input information in the input information memory 12c within the most recent second period. However, the disclosure is not limited thereto. For example, the input information from which the velocity is acquired may be the input information in the input information memory 12c within a shorter period than the most recent second period or the input information in the input information memory 12c within a longer period than the most recent second period.

In the above embodiments, in the case of switching the performance pattern Pa in the processing of S31 of FIG. 6, automatic performance according to the performance pattern Pa acquired in the processing of S30 is started after automatic performance according to the performance pattern Pa before switching that is being automatically performed has been performed until its end. However, the disclosure is not limited thereto. Automatic performance according to the performance pattern Pa acquired in the processing of S30 may be performed at a timing earlier than the end of the performance pattern Pa before switching that is being automatically performed.

For example, when the processing of S31 is executed, if the performance pattern Pa being automatically performed is in the middle of a certain beat, automatic performance may be performed in this performance pattern Pa until this beat, and automatic performance according to the performance pattern Pa acquired in the processing of S30 may be started from the next beat.

In the above embodiments, in the processing of S47 of FIG. 7, the volume of each performance part after change is immediately applied to the performance pattern Pa being automatically performed. However, the disclosure is not limited thereto. For example, if the performance pattern Pa being automatically performed is ongoing when the processing of S47 is executed, automatic performance may be performed until the end of the performance pattern Pa at the volume before change, and automatic performance may be performed at the volume after change from the start of the next performance pattern Pa. When the processing of S47 is executed, if the performance pattern Pa being automatically performed is in the middle of a certain beat, automatic performance may be performed at the volume before change until this beat, and automatic performance may be performed at the volume after switching from the next beat.

In the above embodiments, in (j) of FIG. 2, a key range set in the rhythm key range kH or the velocity key range kV is a sequential range of the keys 2a on the keyboard 2. However, the disclosure is not limited thereto. For example, a key range may be composed of scattered keys 2a on the keyboard 2. For example, white keys 2a in the key range kL in (j) of FIG. 2 may be set as the rhythm key range kH, and black keys 2a in the key range kR may be set as the velocity key range kV.

In the above embodiments, the synthesizer 1 is illustrated as an example of the automatic performance device. However, the disclosure is not limited thereto, and may be applied to an electronic musical instrument such as an electronic organ or an electronic piano, in which the performance pattern Pa can be automatically performed along with musical sounds produced by the performer's performance.

In the above embodiments, the performance information is configured to be inputted from the keyboard 2. However, instead of this, a configuration is possible in which an external keyboard of the MIDI standard may be connected to the synthesizer 1 and the performance information may be inputted from such a keyboard. Alternatively, a configuration is possible in which the performance information may be inputted from MIDI data stored in the flash ROM 11 or the RAM 12.

In the above embodiments, as the performance pattern Pa used for automatic performance, an example is given where notes are set in chronological order. However, the disclosure is not limited thereto. For example, voice data of human singing voices or applause or animal cries or the like may also be taken as the performance pattern Pa used for automatic performance.

In the above embodiments, an accompaniment sound or musical sound is configured to be outputted from the sound source 13, the DSP 14, the DAC 16, the amplifier 17 and the speaker 18 provided in the synthesizer 1. However, instead of this, a configuration is possible in which a sound source device of the MIDI standard may be connected to the synthesizer 1, and an accompaniment sound or musical sound of the synthesizer 1 may be inputted from such a sound source device.

In the above embodiments, the control program 11a is stored in the flash ROM 11 of the synthesizer 1 and is configured to be operated on the synthesizer 1. However, the disclosure is not limited thereto, and the control program 11a may be configured to be operated on any other computer such as a personal computer (PC), a mobile phone, a smartphone or a tablet terminal. In this case, the performance information may be inputted from, instead of the keyboard 2 of the synthesizer 1, a keyboard of the MIDI standard or a keyboard for text input connected to the PC or the like in a wired or wireless manner, or the performance information may be inputted from a software keyboard displayed on a display device of the PC or the like.

The numerical values mentioned in the above embodiments are examples, and it is of course possible that other numerical values may be used.

What is claimed is:

1. An automatic performance device, comprising:
a pattern storage part, storing a plurality of performance patterns;
a performing part, performing a performance based on the performance pattern stored in the pattern storage part;
an input part, inputting performance information from an input device;
a rhythm detection part, detecting a rhythm from the performance information inputted by the input part;
an acquisition part, acquiring from among the plurality of performance patterns stored in the pattern storage part the performance pattern corresponding to the rhythm detected by the rhythm detection part; and
a switching part, switching the performance pattern being performed by the performing part to the performance pattern acquired by the acquisition part.

2. The automatic performance device according to claim 1, wherein
the performance information comprises pitch; and
the rhythm detection part detects the rhythm from the performance information of a predetermined pitch in the performance information inputted by the input part.

3. The automatic performance device according to claim 2, wherein
the input device comprises a keyboard comprising a plurality of keys; and
the rhythm detection part detects the rhythm from the performance information inputted by the key corresponding to a left-hand part played by a performer's left hand on the keyboard in the performance information inputted by the input part.

4. The automatic performance device according to claim 1, wherein
the rhythm detection part detects the rhythm from the performance information inputted by the input part within a first period that is most recent.

5. The automatic performance device according to claim 1, wherein
the performance information comprises velocity; and
the automatic performance device further comprises:
a velocity detection part, detecting a velocity from the performance information inputted by the input part; and
a volume change part, changing a volume of the performance pattern being performed by the performing part based on the velocity detected by the velocity detection part.

6. The automatic performance device according to claim 5, wherein
the performance information comprises pitch; and
the velocity detection part detects the velocity from the performance information of a predetermined pitch in the performance information inputted by the input part.

7. The automatic performance device according to claim 6, wherein
the input device comprises a keyboard comprising a plurality of keys; and
the velocity detection part detects the velocity from the performance information inputted by the key corresponding to a right-hand part played by a performer's right hand on the keyboard in the performance information inputted by the input part.

8. The automatic performance device according to claim 5, wherein
the velocity detection part detects the velocity from the performance information inputted by the input part within a second period that is most recent.

9. The automatic performance device according to claim 5, wherein
the performance pattern comprises a plurality of performance parts; and
the volume change part changes the volume of each of the performance parts of the performance pattern being performed by the performing part based on the velocity detected by the velocity detection part.

10. The automatic performance device according to claim 5, wherein
the volume change part comprises:
a difference calculation part, calculating a differential value being a value obtained by subtracting from the velocity detected by the velocity detection part a reference value serving as a reference of the velocity; and
a set value acquisition part, acquiring a set value of the volume of the performance pattern, wherein
a value obtained by adding a value based on the differential value calculated by the difference calculation part to the set value of the volume acquired by the set value acquisition part is applied to the volume of the performance pattern being performed by the performing part.

11. The automatic performance device according to claim 10, wherein
the reference value is an approximately intermediate value between a minimum possible value and a maximum possible value of the velocity.

12. A non-transitory computer-readable medium, storing an automatic performance program that causes a computer to execute automatic performance, the computer comprising a storage part and an input part that inputs performance information, wherein
the automatic performance program causes the storage part to function as a pattern storage part storing a plurality of performance patterns, and causes the computer to:
perform a performance based on the performance pattern stored in the pattern storage part;
input the performance information by the input part;
detect a rhythm from the inputted performance information;
acquire from among the plurality of performance patterns stored in the pattern storage part the performance pattern corresponding to the detected rhythm; and
switch the performance pattern being performed to the acquired performance pattern.

13. The non-transitory computer-readable medium according to claim 12, wherein
the performance information comprises pitch; and
the automatic performance program further causes the computer to detect the rhythm from the performance information of a predetermined pitch in the performance information inputted by the input part.

14. The non-transitory computer-readable medium according to claim 13, wherein
the input part comprises a keyboard comprising a plurality of keys; and
the automatic performance program further causes the computer to detect the rhythm from the performance information inputted by the key corresponding to a left-hand part played by a performer's left hand on the keyboard in the performance information inputted by the input part.

15. The non-transitory computer-readable medium according to claim 12, wherein
the automatic performance program further causes the computer to detect the rhythm from the performance information inputted by the input part within a first period that is most recent.

16. The non-transitory computer-readable medium according to claim 12, wherein
the performance information comprises velocity; and
the automatic performance program further causes the computer to:
detect a velocity from the performance information inputted by the input part; and
change a volume of the performance pattern being performed based on the detected velocity.

17. An automatic performance method, executed by an automatic performance device comprising a pattern storage part storing a plurality of performance patterns and an input device inputting performance information, wherein the automatic performance method comprises:
performing a performance based on the performance pattern stored in the pattern storage part;
inputting the performance information by the input device;
detecting a rhythm from the inputted performance information;
acquiring from among the plurality of performance patterns stored in the pattern storage part the performance pattern corresponding to the detected rhythm; and
switching the performance pattern being performed to the acquired performance pattern.

18. The automatic performance method according to claim 17, wherein
the performance information comprises pitch; and
the detecting the rhythm comprises detecting the rhythm from the performance information of a predetermined pitch in the performance information inputted by the input device.

19. The automatic performance method according to claim 18, wherein
the input device comprises a keyboard comprising a plurality of keys; and
the detecting the rhythm comprises detecting the rhythm from the performance information inputted by the key corresponding to a left-hand part played by a performer's left hand on the keyboard in the performance information inputted by the input device.

20. The automatic performance method according to claim 17, wherein
the detecting the rhythm comprises detecting the rhythm from the performance information inputted by the input device within a first period that is most recent.
